(19) United States
(12) Patent Application Publication
(10) Pub. No.: US 2008/0197244 A1
(43) Pub. Date: Aug. 21, 2008

(54) Device For Storing Cables In An Orderly Manner

(76) Inventor: Lydia Bechmann, Munchen (DE)

Correspondence Address: MICHAEL BEST & FRIEDRICH LLP, 100 E WISCONSIN AVENUE, Suite 3300, MILWAUKEE, WI, 53202, US

(21) Appl. No.: 11/915,764

(22) PCT Filed: Apr. 26, 2006
(86) PCT No.: PCT/EP2006/003875

§ 371 Date: Nov. 28, 2007

(30) Foreign Application Priority Data
May 30, 2005 (DE) 102005024681.8

(51) Int. Cl. F16L 3/12

(52) U.S. Cl. 248/74.3

(57) ABSTRACT

A device (10) for storing cables, especially computer, audio or like cables, in an orderly manner, of a cable tie type, having a holding strap (11) whose ends are releasably connectible to one another whilst forming a loop around a length of cable (12) collected together especially in a meandering shape, a labeling field being associated with that holding strap (11). Furthermore, the holding strap (11) comprises a distinct device (15) for attachment to the cable (2), especially in the form of a cord loop.

### RELATED APPLICATION DATA

This application claims priority from German Patent Application No. DE200510024681, filed on May 30, 2005 and PCT Application No. PCT/EP2006/003875, filed Apr. 26, 2006, both of which are incorporated by reference herein.

### BACKGROUND

The invention relates to a device for storing cables, especially computer, audio, video, network, musicians or like cables, in an orderly manner, of a cable tie type, having a strap whose ends are releasably connectible to one another whilst forming a loop around a length of cable collected together especially in a meandering shape, a labeling field being associated with that strap.

A device of such a kind is known from DE 87 06 091 U1. Attachment of the holding strap to the cable is carried out by pulling an end thereof, after forming a loop around a length of cable, through a ring arranged at the other end of the strap. Furthermore, with both ends of the strap there are associated complementary hook-and-loop closure portions, making it possible to form a strap loop which can be opened. In the known arrangement it is disadvantageous that the strap, defining a so-called “universal tie”, is not attached in captive manner to the cable or the like which is to be stored. There is accordingly a risk that when the strap is released from the cable, the labeling field will have to be re-labeled when the universal tie is reused. Even though arrangements are also made for the strap to remain lastingly connected to the associated cable or length of cable, by pressing shut the above-mentioned ring using pliers, this action has a lasting effect on the universal tie such that the latter can only be removed again from the cable or length of cable, if so required, by means of a further tool. In addition there is a risk that, as a result of the above-mentioned action on the ring, the latter will break when it is bent open with the consequence that it would then no longer be possible to reuse the universal tie.

In addition, the known universal tie has the disadvantage that no associated device is provided for hanging up the universal tie and the associated cable.

Otherwise, cable ties made of plastics strips or rods are frequently used in the work sector and private sector for keeping bundled cables. These cable ties are distinguished by the fact that they can in principle be used only once because their ends are not releasably connected to one another. In addition, the customary commercial plastics cable ties do not have labeling fields so that they are not suitable for storing cables in an orderly manner. The conventional cable ties of plastics material also lack distinct means for hanging up.

### SUMMARY

The present invention is accordingly based on the problem of providing a device of the kind mentioned at the beginning which is connectible in captive manner to an associated cable, with it being possible, if so required, for that connection to be opened, or released, at any time. It should also be possible using the device according to the invention to hang up the respectively associated cables in an orderly manner.

The problem is solved on the one hand by means of the fact that the strap has a distinct device for attachment to the cable; this means that the holding strap is not used for attaching to the associated cable directly but rather a distinct device is provided for that purpose, which device is of course connected to the holding strap.

In a preferred embodiment, on the other hand, arrangements are further made for the device to have a hanging device, especially a hanging loop, by means of which the held-together cable can be hung up in an orderly manner.

It is especially advantageous for the device for attaching the holding strap to the cable to comprise a cord loop, the free end of which can be tightened around the cable. This connection can be opened at any time by simple means so that the device can be used in another situation, if required. The cord loop can be based on a band of rubber, as a result of which a flexible connection between the holding strap and the cable is obtained.

A further advantageous detail is that a hanger, especially a hanging loop, is preferably associated with the holding strap in order to hang up the device.

Furthermore, in an advantageous embodiment, arrangements are made for the free ends of the holding strap to be connectible by means of a hook-and-loop closure, a press-stud closure and/or a button/buttonhole closure.

Alternatively, it is also feasible for the free ends to be joined to one other by means of a tied bow or a knot.

Finally, arrangements can furthermore be made for the holding strap to have intended tearing lines arranged at predetermined spacings from one another for separating off sub-portions so that the holding strap can optionally be shortened in accordance with requirements without requiring a tool for the purpose.

The labeling field is preferably part of a tag which is attachable to the strap.

Also, the cable attachment device and/or the hanging loop are preferably attached to the above-mentioned tag.

The arrangement of the labeling field on or in a distinct tag makes it possible to form an insertion pocket having a window, into which pocket a labeling slip can be inserted.

As a result of the attachment of the cable attachment device and the hanger loop to the tag, the device especially advantageously encompasses the captive cable attachment, the orderly hanging-up and also the labeling.

An especially advantageous embodiment of the device according to the invention is characterized in that the hanger is formed by a strip of material that is relatively rigid compared to the holding strap, especially by a strip of plastics material, having a cut-out for hanging up on a wall nail or like hanging means. The cut-out is preferably in the form of an opening stamped out in the mentioned strip of material.

The holding strap is connected to the mentioned hanger, more specifically being preferably so applied to that flat face of the hanger which defines the underside that between the holding strap and the hanger there is formed a passageway for accommodating a length of cable, that passageway defining the distinct cable attachment device.

The holding strap can, in a preferred embodiment, be so formed that it is of two parts, the first portion being directly attached to the hanger, whilst the other, second portion is attached to the first portion with overlapping of one of the two ends of the first portion, the passageway for accommodation of a length of cable being arranged to be formed between the overlapping part of the second portion and the first portion.

The strip of material which defines the hanger has a width which corresponds approximately to the width of the holding strap. The thickness of the hanger is approximately two to three times greater than the thickness of the holding strap. The strip of material defining the hanger can also be formed by a plastics-sheathed textile strap.

A further particular embodiment is characterized in that the hanger has, on its end portion located opposite the hanging opening, at least one lateral cut-out so that this end portion is anchorable in the hanging opening of the hanger with a further corresponding device for storing cables in an orderly manner. As a result, a plurality of devices of this kind can be connected together in a row, and consequently a plurality of different cables stored in an orderly manner.

Several embodiments of the device according to the invention will be explained herein below in greater detail with reference to the accompanying drawings.

### BRIEF DESCRIPTION OF THE DRAWINGS

FIG. 1 is a top view of a device constructed in accordance with the invention for storing cables or the like;

FIG. 2 shows the device of FIG. 1 connected to a cable and hung up on a hook;

FIG. 3 shows the above-mentioned device according to FIG. 2 holding together a length of cable formed with folds in a meandering shape;

FIG. 4 is a top view of a second embodiment of a device constructed in accordance with the invention;

FIG. 5 is a side view of the device according to FIG. 4;

FIG. 6 is a top view of the device according to FIGS. 4 and 5 storing a length of cable formed with folds in a meandering shape;

FIG. 7 is a side view of the device according to FIG. 6; and

FIG. 8 is a top view of two devices according to FIG. 6 connected to one another to form one unit.

### DETAILED DESCRIPTION

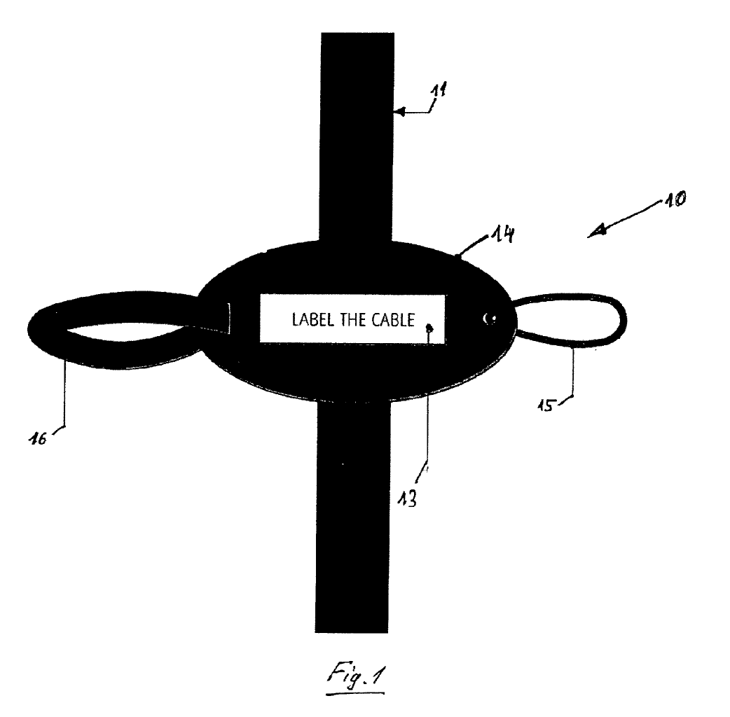

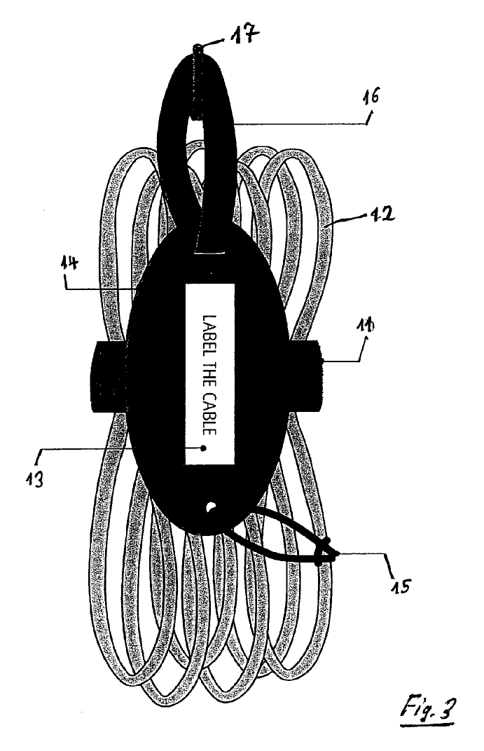

FIG. 1 shows a device for storing cables, for example computer, audio or video cables, in an orderly manner, which device is constructed in the manner of a cable tie. This device is denoted by reference numeral 10. It has a holding strap 11 whose ends are releasably connectible to one another whilst forming a loop around a length of cable 12 (see FIG. 3) collected together especially in a meandering shape, complementary hook-and-loop regions being associated with the free ends of the strap 11 for that purpose, more specifically on flat faces of the strap 11 lying opposite one another, in order to be able to form a closed loop around a collected-together length of cable 12 (see FIG. 3 in that regard).

A tag 14 is attached to the holding strap 11, which tag has an insertion pocket having a window 15 for accommodating a labeling slip. The tag 14 is either stitched or adhesively bonded to the strap 11.

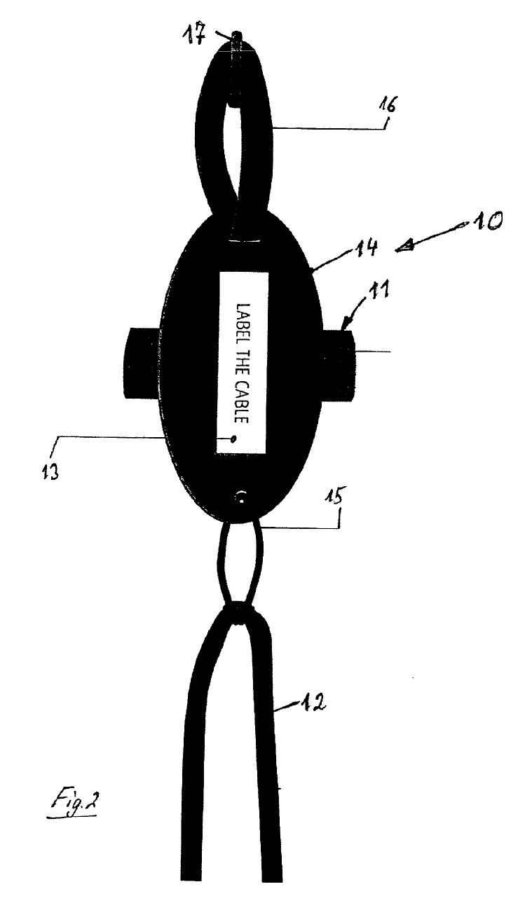

Arranged on the two narrow sides of the oval-shaped tag 14 located opposite one another are, on one side, a hanging loop 16 and, on the other side, a cable attachment device 15 in the form of a cord loop. The hanging loop serves for hanging up the device, with or without cable, on a wall- or shelf-hook 17 (see FIG. 2).

The free end of the attachment loop 15 is looped around a cable 12 in accordance with FIG. 2, more specifically encircling the cable 12. For that purpose, after the free end of the cord loop 15 has been looped around, the whole device 10 is pulled through the free end of the loop. As a result, the loop around the cable 12 is attached to the cable 12. This loop is releasable again at any time if so required. In addition it is advantageous that the cable is attached to the device 10 with a spacing from the holding strap 11. As a result the cable can be held in the collected-together state with freedom from constraints, as is shown in FIG. 3. In this context, freedom from constraints means that even in the case of cable 12 collected together in a meandering shape the tag 14 and also, as a result, the labeling field and the window 15 associated therewith extend over the collected-together cable 12 substantially without deformation. Preferably, for that purpose the cord loop 15 is formed by a rubber loop, as a result of which even greater “freedom from constraints” is obtained.

The holding strap 11 can have intended tearing lines arranged at predetermined spacings from one another so that, if so required, it can be shortened to a greater or lesser extent, without a tool. On the other hand, it is of course also feasible, for the purpose of shortening the holding strap 11, to cut off appropriately long end portions using scissors.

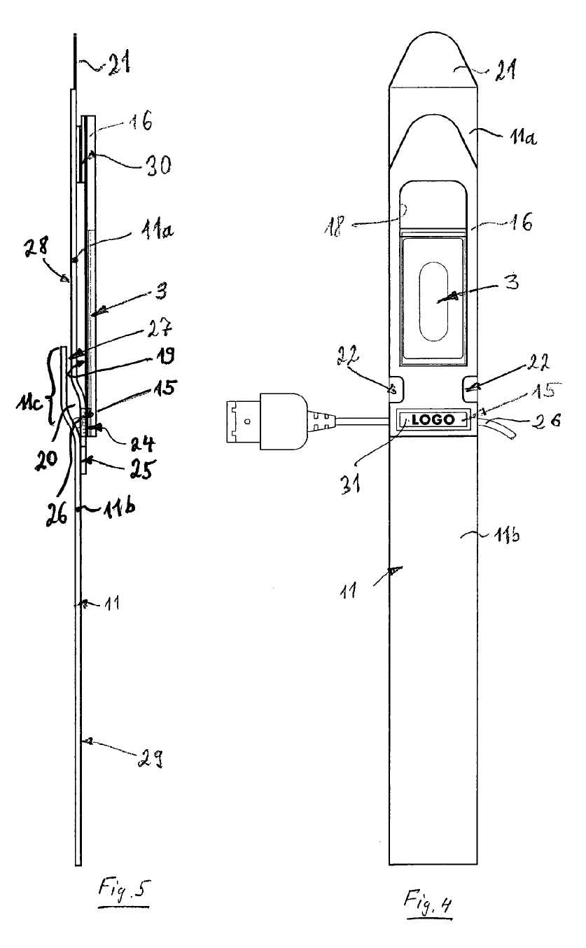

FIGS. 4 to 7 show a further embodiment of a device according to the invention for storing lengths of cable. This further embodiment is characterized in that the hanger 16 is formed by a strip of material that is relatively rigid compared to the holding strap 11, especially by a strip of plastics material or of plastics-sheathed textile, having an opening or cut-out 18 for hanging up on a wall nail, a screw, a hook or like hanging means. The holding strap 11 is so attached to that flat face 19 of the hanger 16 which defines the underside (see FIG. 5) that a passageway 20 is formed between it and the hanger 16 for accommodation of a length of cable. This passageway defines the cable attachment device 15 already described hereinbefore with reference to the first embodiment. In the case of the embodiment now being described the cable attachment device 15 is therefore not a distinct component as in the case of the first embodiment but rather is integrated between the holding strap and the hanger.

In addition, in the case of the embodiment according to FIGS. 4-8, the tag and the hanging loop of the first embodiment are integrated into a single structural unit.

In the case of the embodiment according to FIGS. 4-8, the holding strap 11 is of two parts, the first portion 11 a being directly attached to the hanger 16, for example being stitched thereto (see stitching region 24 in FIG. 5), whilst the other, second portion 11b is attached to the first portion 11a, for example likewise stitched or also welded thereto (see stitching region 25 in FIG. 5), with overlapping of the bottom (in FIG. 5) end of the first portion 11a. The passageway for accommodation of a length 26 of cable can be formed between the overlapping part 11c of the second portion 11b and the first portion 11a. For that purpose, the free end of the overlapping part 11c is connectible to the underneath part of the first holding strap portion 11a, preferably by means of a hook-and-loop connection, which is indicated in FIG. 5 by reference numeral 27.

A part of the holding strap 11, especially the part which extends over the underside of the hanger 16, namely the portion 11a, is provided on its face directed away from the hanger 16 with hook-and-loop-closure hooks, which correspond to a complementary fleece layer on the opposite face, or top face, of the other part of the holding strap 11, namely portion 11b, or vice-versa. That face of the portion 11a which is provided with hook-and-loop-closure hooks is identified by reference numeral 28, and that face of the portion 11b of the holding strap which is provided with a fleece layer is identified by reference numeral 29.

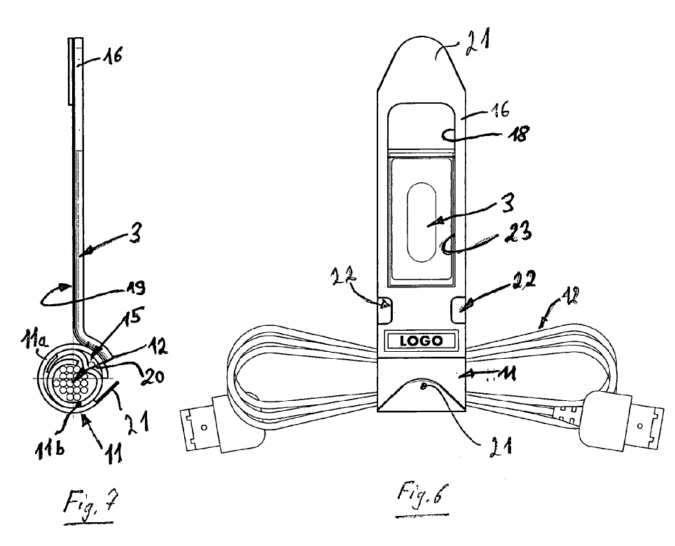

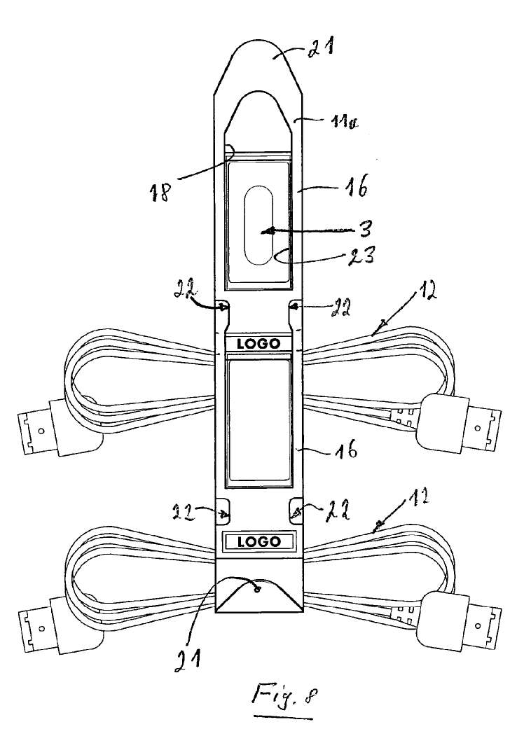

For the purpose of storing a length of cable, in accordance with FIGS. 6 and 7, the fleece-layer-free face of that part of the holding strap 11 which is provided with the fleece layer 29, namely of portion 11b, is so wrapped around the lengths of cable 12, collected together in a meandering shape, that the fleece-bearing face 29 of the holding strap portion 11b is to the outside and that face 28 of the other portion 11a which has the hook-and-loop-closure hooks can be wrapped over the fleece-bearing face of the portion 11b. By that means, the holding strap portion 11b is held in position wrapped around the collected-together lengths of cable 12 (see FIGS. 6 and 7).

A grip strip 21 is formed at the free end of the holding strap portion 11a. For this purpose, preference is given to a rubber-like material or plastics material being injection-molded around the free end of the holding strap portion 11a. It is also feasible for that free end to be masked with a foil.

In the embodiment shown, the grip strip projects out beyond the hanger 16 so that access through the hanger 16 is not impeded.

That face of the holding strap 11, especially of the first portion 11a, which is directed towards the hanger 16 can also be releasably connected to the hanger 16, namely to the underside thereof. In that case a hook-and-loop connection is provided instead of the stitched connection 24. For reasons of practicability, however, the connection is preferably permanent, as is described hereinbefore. Moreover it should also be pointed out that the stitched connection 24, and also the connection 25, can be replaced by a welded connection.

Also of particular importance is the fact that the hanger 16 has, on its end portion located opposite the hanging opening 18, two lateral cut-outs 22 so that this end portion can be anchored in the hanging opening 18 of the hanger 16 of a further corresponding device of that kind, as is shown in FIG. 8. As a result, a plurality of hangers together with associated holding straps can be connected one after the other, that is to say together in a row, so that the device serves for storing a plurality of different lengths of cable 12.

Finally it should also be mentioned that the labeling field 3 in the shown embodiments according to FIGS. 4 to 8 is arranged inside a window 23 of the hanger 16, which window is covered by a transparent foil.

For the purpose of better presentation of the device according to FIGS. 4-8, arrangements are also made for the free end of the holding strap portion 11a to be connectible to the hanger 16, more specifically preferably by means of a hook-and-loop closure 30. As a result the device can be put together flat in accordance with FIG. 5 and also presented held together flat in corresponding manner, for example within a so-called blister pack.

The top face or viewed face of the hanger 16 is also provided in the region of the passageway 20 with a field 31 for labeling, a Trade Mark or the like. This field 31 is occupied in each of FIGS. 4, 6 and 8 by the text “LOGO”.

All features disclosed in the application documents are claimed as being important to the invention insofar as they are novel on their own or in combination compared with the prior art.

Thus, the invention provides, among other things, a device for storing cables in an orderly manner. Various features and advantages of the invention are set forth in the following claims.

1-19. (canceled)

20. A device for storing cables in an orderly manner, said device being of a cable tie type and comprising:
a holding strap having ends configured to releasably connect to one another, said holding strap configured to form a loop around a length of cable that is collected together;
a labeling field associated with said holding strap; and
a dedicated cable attachment device configured to attach to said length of cable.

21. A device according to claim 20, wherein said cable attachment device includes a cord loop having a free end, said free end configured to be tightened around said cable.

22. A device according to claim 20, wherein a hanger is associated with said holding strap and is configured to hang up said device.

23. A device according to claim 20, wherein said holding strap ends are configured to be connected by at least one of a hook-and-loop closure, a press-stud closure, and a button/buttonhole closure.

24. A device according to claim 20, wherein said holding strap ends are configured to be joined to one other by means of at least one of a tied bow and a knot.

25. A device according to claim 20, wherein said holding strap has intended tearing lines arranged at predetermined spacings from one another configured to separate sub-portions and thereby shorten said strap.

26. A device according to claim 20, wherein said labeling field is part of a tag that is configured to be attached to said holding strap.

27. A device according to claim 26, wherein at least one of said cable attachment device and said hanger is attached to said tag.

28. A device according to claim 22, wherein said hanger is formed by a strip of material that is relatively rigid compared to said holding strap, said strip having a cut-out configured to hang from a hook.

29. A device according to claim 28, wherein said hanger has a flat face, and wherein said holding strap is applied to said flat face of said hanger, and between said holding strap and said hanger is formed a passageway configured to accommodate said length of cable, said passageway defining said cable attachment device.

30. A device according to claim 29, wherein said holding strap comprises first and second portions, said first portion is directly attached to said hanger, said second portion is attached to said first portion and includes an overlapping portion that overlaps an end of said first portion, said passageway for accommodation of said length of cable being formed between said overlapping part of said second portion and said first portion.

31. A device according to claim 30, wherein said overlapping portion of said second holding strap portion is releasably fastened to said first portion.

32. A device according to claim 29, wherein said first portion and said second portion together comprise a hook-and-loop fastener having a hook portion and a loop portion, wherein said first portion includes one of said hook portion and said loop portion, and said second portion includes the other of said hook portion and said loop portion, said first portion configured to releasably connect to said second portion by way of said hook-and-loop-fastener.

33. A device according to claim 32, wherein said length of cable is held in position inside an enclosure formed by said first portion and said second portion when said first portion and said second portion are releasably connected.

34. A device according to claim 28, wherein a grip strip is formed at an end of said holding strap.

35. A device according to claim 34, wherein said grip strip is configured to project out beyond said hanger so that access through said hanger is not disrupted.

36. A device according to claim 29, wherein said holding strap is configured to be releasable connected to said hanger.

37. A device according to claim 28, wherein said hanger has, on an end portion located opposite said cut-out, at least one lateral cut-out so that said end portion is configured to be anchored in said cut-out of said hanger of another device.

38. A device according to claim 20, wherein said labeling field is arranged inside a window of said hanger, wherein said window is configured to be covered with a transparent foil.
